(19) United States
(12) Patent Application Publication
(10) Pub. No.: US 2025/0192452 A1
(43) Pub. Date: Jun. 12, 2025

(54) TERMINAL-EQUIPPED ELECTRIC WIRE

(71) Applicant: Yazaki Corporation, Tokyo (JP)

(72) Inventor: Makoto KOSHIISHI, Shizuoka (JP)

(73) Assignee: Yazaki Corporation, Tokyo (JP)

(21) Appl. No.: 18/969,934

(22) Filed: Dec. 5, 2024

(30) Foreign Application Priority Data
Dec. 11, 2023 (JP) 2023-208232

(51) Int. Cl. H01R 4/18; H01R 11/28

(52) U.S. Cl. CPC H01R 4/185; H01R 11/28

(57) ABSTRACT

A terminal-equipped electric wire includes an electric wire including a conductor and an insulative coating that covers the conductor, and a crimp terminal including a conductor crimp portion that crimps the conductor, a coating fastening portion that includes a first fastening piece and a second fastening piece and fastens the insulative coating of the electric wire by the first fastening piece and the second fastening piece, and an intermediate portion that connects the conductor crimp portion and the coating fastening portion, wherein an outer surface of the first fastening piece and an outer surface of the second fastening piece contact with each other, and an upper end of a side wall of the intermediate portion is higher than an upper end of the conductor.

### CROSS-REFERENCE TO RELATED APPLICATIONS

The present application is based on and claims the benefit of priority from the prior Japanese Patent Application No. 2023-208232, filed on Dec. 11, 2023, the entire contents of which are incorporated by reference herein.

### TECHNICAL FIELD

The present disclosure relates to a terminal-equipped electric wire.

### BACKGROUND

A wire harness for an automobile includes a plurality of terminal-equipped electric wires. The terminal-equipped electric wire includes an electric wire and a crimp terminal that is crimped onto the electric wire, and the crimp terminal is accommodated in a terminal accommodation room of a connector housing. In the related-art, in order to suppress corrosion caused by influences such as water splash and condensation, it is known to apply an anti-corrosive material between a core wire (conductor) of the electric wire and the crimp terminal.

JP2020-191196A discloses a terminal-equipped electric wire including a crimp terminal and an anti-corrosive material. The crimp terminal includes a coating crimp portion that is crimped onto a coating. The anti-corrosive material integrally covers an area from a distal end of a core wire to a side surface of the coating crimp portion, and shields the core wire from an external space. The coating crimp portion includes a bottom wall portion, a first fastening piece, and a second fastening piece, each of which adheres closely to the coating, and the coating crimp portion is crimped onto the coating while stacking the first fastening piece on a distal end portion of the second fastening piece. The anti-corrosive material closes, from the core wire crimp portion side, a gap surrounded by a distal end surface of the second fastening piece, an inner surface of the first fastening piece, and an outer surface of the coating. According to the terminal-equipped electric wire described in JP2020-191196A, penetration of water through the coating crimp portion can be suppressed.

### SUMMARY OF THE INVENTION

Incidentally, an electric wire having a size smaller than an optimized size for the crimp terminal is crimped in some cases. However, in such a case, when crimping is performed while overlapping the first fastening piece on the distal end portion of the second fastening piece, there may be a risk that a side wall of an intermediate portion that connects the core wire crimp portion and the coating crimp portion to each other is rolled inward together with the first fastening piece or the second fastening piece. However, in a case where the side wall of the intermediate portion collapses inward along the electric wire, when a liquid anti-corrosive material is applied, there may be a risk that the anti-corrosive material is no longer retained inside the side wall and drip down along the outer surface of the side wall.

The present disclosure has been made in view of such a problem in the related art. Further, an object of the present disclosure is to provide a terminal-equipped electric wire that can prevent an anti-corrosive material from dripping down from a side wall of an intermediate portion.

A terminal-equipped electric wire according to an aspect of the present disclosure include an electric wire including a conductor and an insulative coating that covers the conductor; and a crimp terminal including a conductor crimp portion that crimps the conductor, a coating fastening portion that includes a first fastening piece and a second fastening piece and fastens the insulative coating of the electric wire by the first fastening piece and the second fastening piece, and an intermediate portion that connects the conductor crimp portion and the coating fastening portion, wherein an outer surface of the first fastening piece and an outer surface of the second fastening piece contact with each other, and an upper end of a side wall of the intermediate portion is higher than an upper end of the conductor.

According to the present disclosure, it is possible to provide a terminal-equipped electric wire that can prevent an anti-corrosive material from dripping down from a side wall of an intermediate portion.

### BRIEF DESCRIPTION OF DRAWINGS

FIG. 1 is a perspective view illustrating one example of a terminal-equipped electric wire according to the present embodiment.

FIG. 2 is a side view illustrating one example of the terminal-equipped electric wire according to the present embodiment.

FIG. 3 is a cross-sectional view taken along the line III-III in FIG. 2.

FIG. 4 is a cross-sectional view taken along the line IV-IV in FIG. 2.

### DETAILED DESCRIPTION OF THE INVENTION

With reference to the drawings, a terminal-equipped electric wire according to the present embodiment is described in detail. Note that the dimensional ratios in the drawings are exaggerated for explanatory purposes, and may differ from the actual ratios.

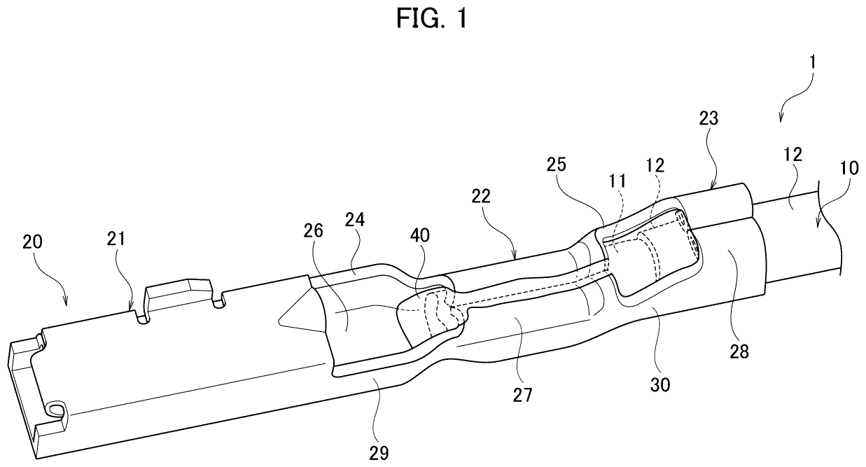

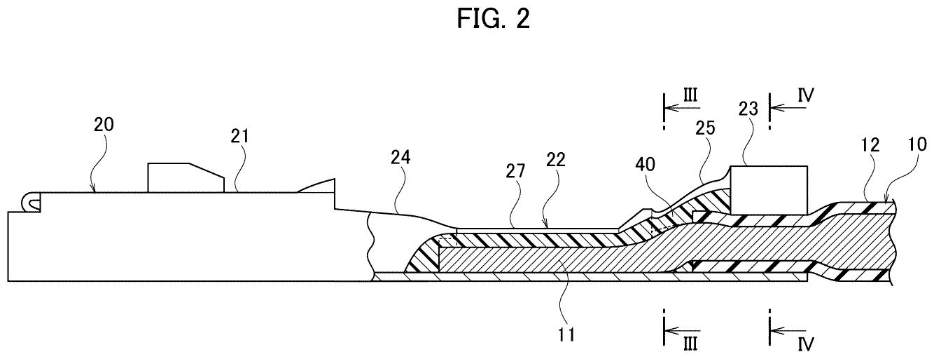

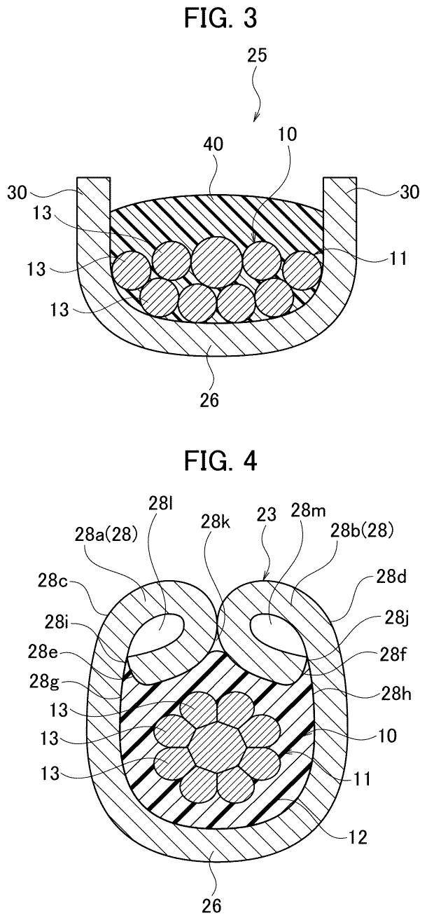

A terminal-equipped electric wire 1 according to the present embodiment is described with reference to FIG. 1 to FIG. 4. FIG. 1 is a perspective view illustrating one example of the terminal-equipped electric wire 1 according to the present embodiment. FIG. 2 is a side view illustrating one example of the terminal-equipped electric wire 1 according to the present embodiment. FIG. 3 is a cross-sectional view taken along the line III-III in FIG. 2. FIG. 4 is a cross-sectional view taken along the line IV-IV in FIG. 2. As illustrated in FIG. 1 to FIG. 4, the terminal-equipped electric wire 1 according to the present embodiment includes an electric wire 10, a crimp terminal 20, and an anti-corrosive material 40.

The electric wire 10 includes a conductor 11 and an insulative coating 12 that covers an outer circumference of the conductor 11. The conductor 11 includes a plurality of strands 13. At the end portion of the electric wire 10, the insulative coating 12 is peeled off, and the conductor 11 is exposed from the insulative coating 12. The conductor 11 may include an assembled strand wire obtained by bundling the plurality of strands 13. The conductor 11 may be configured by a single strand wire or a composite strand wire obtained by stranding a plurality of assembled strand wires.

The conductor 11 may contain copper or aluminum as a main component. Note that the main component indicates a metal component with the highest molar ratio among metal components contained in the conductor 11. The metal component with the highest molar ratio among the metal components contained in the conductor 11 may be present in a molar ratio of 50% or more, 60% or more, 70% or more, 80% or more, 90% or more, or 95% or more. The material of the conductor 11 may be, for example, copper, aluminum, or an alloy containing these metal components. In view of weight reduction, the conductor 11 is preferably formed of aluminum or an aluminum alloy.

As the material of the insulative coating 12, a thermal plastic resin that can exert an electric insulating property may be used. For example, the insulative coating 12 may contain at least any one of an olefin-based resin and polyvinyl chloride. The olefin-based resin may include at least one or more resins selected from a group consisting of, for example, polyethylene (PE), polypropylene (PP), an ethylene copolymer, and a propylene copolymer.

The crimp terminal 20 includes a terminal connection portion 21, a conductor crimp portion 22, a coating fastening portion 23, a first intermediate portion 24, and a second intermediate portion 25. The terminal connection portion 21 is provided to one end portion of the crimp terminal 20, and the conductor crimp portion 22 is provided to the other end portion of the crimp terminal 20. Note that, in the present specification, description is made while assuming that the side of the crimp terminal 20 on which the terminal connection portion 21 is provided is a front side and the side thereof on which the coating fastening portion 23 is provided is a rear side.

The terminal connection portion 21 is provided to a front portion of the crimp terminal 20 in a longitudinal direction, and is configured to be connected to a counterpart terminal, which is omitted in illustration. When the terminal connection portion 21 is connected to a terminal connection portion of the counterpart terminal, the crimp terminal 20 is mechanically and electrically connected to the counterpart terminal. The terminal connection portion 21 has a box-like shape having a cylinder-like space inside, and accommodates a spring piece inside so as to be engaged with the counterpart terminal.

The conductor crimp portion 22 is provided on the rear side of the crimp terminal 20 in the longitudinal direction with respect to the terminal connection portion 21. Specifically, the conductor crimp portion 22 is provided between the terminal connection portion 21 and the coating fastening portion 23 in the longitudinal direction of the crimp terminal 20. The conductor crimp portion 22 crimps the conductor 11 of the electric wire 10, which has a terminal end being exposed. The conductor crimp portion 22 fastens and crimps the conductor 11 of the electric wire 10, and directly contacts with the conductor 11. The conductor crimp portion 22 includes a bottom plate 26 on which the conductor 11 is placed and a pair of conductor fastening pieces 27 that are connected to the bottom plate 26 and wrap and fasten the conductor 11 in a radial direction. The pair of conductor fastening pieces 27 extend upward from edge portions of both right and left sides of the bottom plate 26. Before crimping of the electric wire 10, the conductor crimp portion 22 is formed to have a U-like shape in a cross-sectional view by the bottom plate 26 and the pair of conductor fastening pieces 27.

The coating fastening portion 23 is provided on the rear side of the crimp terminal 20 in the longitudinal direction with respect to the conductor crimp portion 22. The coating fastening portion 23 fastens the insulative coating 12 provided at the end portion of the electric wire 10, and directly contacts with the insulative coating 12. The coating fastening portion 23 includes the bottom plate 26 on which the electric wire 10 is placed, and a pair of fastening pieces 28 that are connected to the bottom plate 26 and wrap and fasten the electric wire 10 in the radial direction. The pair of fastening pieces 28 includes a first fastening piece 28a and a second fastening piece 28b. The first fastening piece 28a is connected to one end portion of the bottom plate 26, and the second fastening piece 28b is connected to the other end portion of the bottom plate 26. Before crimping of the electric wire 10, the first fastening piece 28a and the second fastening piece 28b extend upward from the edge portions on both the right and left sides of the bottom plate 26, and the bottom plate 26, the first fastening piece 28a, and the second fastening piece 28b form a U-like shape or a V-like shape in a cross-sectional view. Further, the coating fastening portion 23 fastens the insulative coating 12 of the electric wire 10 by the first fastening piece 28a and the second fastening piece 28b.

In the terminal-equipped electric wire 1, an outer surface 28c of the first fastening piece 28a and an outer surface 28d of the second fastening piece 28b contact with each other. With this, unlike fastening with overlap, the first fastening piece 28a and the second fastening piece 28b are not curved along the periphery of the electric wire 10. Thus, at the time of fastening by the first fastening piece 28a and the second fastening piece 28b, a side wall 30 of the second intermediate portion 25 can be prevented from collapsing inward and being curved along with the first fastening piece 28a and the second fastening piece 28b. With this, as compared to a state before fastening the insulative coating 12 of the electric wire 10, the height of the side wall 30 of the second intermediate portion 25 can be maintained. Further, by preventing the first fastening piece 28a and the second fastening piece 28b from excessively collapsing inward beyond the side wall 30 of the second intermediate portion 25, it is possible to suppress tearing at the boundary between the side wall 30 of the second intermediate portion 25 and the fastening pieces 28 and prevent generation of a shear crack.

The coating fastening portion 23 may fasten the insulative coating 12 of the electric wire 10 so that the outer surface 28c of the first fastening piece 28a and the outer surface 28d of the second fastening piece 28b contact with the insulative coating 12. With this, a distal end surface 28e of the first fastening piece 28a and a distal end surface 28f of the second fastening piece 28b can be prevented from piercing the insulative coating 12 and damaging the insulative coating 12. With this, when the conductor 11 is exposed from the insulative coating 12, it is possible to suppress penetration of water into the electric wire 10 and suppress corrosion. Note that the distal end surface 28e of the first fastening piece 28a may contact with the insulative coating 12, and may contact with an inner surface 28g of the first fastening piece 28a. Similarly, the distal end surface 28f of the second fastening piece 28b may contact with the insulative coating 12, and may contact with an inner surface 28h of the second fastening piece 28b.

Crimping of the conductor crimp portion 22 and the coating fastening portion 23 is performed by fastening the conductor 11 with an anvil and a crimper, which are omitted in illustration, by the conductor crimp portion 22 and fastening the electric wire 10 covered with the insulative coating 12 by the coating fastening portion 23, and thus the terminal-equipped electric wire 1 can be manufactured.

The first intermediate portion 24 connects the terminal connection portion 21 and the conductor crimp portion 22 to each other in the longitudinal direction of the crimp terminal 20. The first intermediate portion 24 includes the bottom plate 26 and a pair of side walls that extend upward from the edge portions on both the right and left sides of the bottom plate 26. The side wall of the first intermediate portion 24 is configured to be lower than the side wall of the terminal connection portion 21 and the pair of conductor fastening pieces 27 of the conductor crimp portion 22. The first intermediate portion 24 is formed to have a U-like shape or a V-like shape in a cross-sectional view by the bottom plate 26 and the pair of side walls.

The second intermediate portion 25 connects the conductor crimp portion 22 and the coating fastening portion 23 to each other in the longitudinal direction of the crimp terminal 20. The second intermediate portion 25 includes the bottom plate 26 and the pair of side walls 30 that extend upward from the edge portions on both the right and left sides of the bottom plate 26. The side wall of the second intermediate portion 25 is configured to be lower than the pair of conductor fastening pieces 27 of the conductor crimp portion 22 and the pair of fastening pieces 28 of the coating fastening portion 23. The second intermediate portion 25 is formed to have a U-like shape or a V-like shape in a cross-sectional view by the bottom plate 26 and the pair of side walls 30.

In the present embodiment, the crimp terminal 20 is formed by subjecting one plate-like member to fold. Thus, the bottom plate 26 in a form of one commonly-shared sheet is formed continuously from the bottom plate 26 of the terminal connection portion 21 to the bottom plate 26 of the coating fastening portion 23. Further, the front and rear ends of the low side wall of the first intermediate portion 24 are formed continuously with a lower half of the rear end of the side wall of the terminal connection portion 21 and a lower half of the front end of each of the pair of conductor fastening pieces 27 of the conductor crimp portion 22, respectively. The front and rear ends of the low side wall 30 of the second intermediate portion 25 are formed continuously with a lower half of the rear end of each of the pair of conductor fastening pieces 27 of the conductor crimp portion 22 and a lower half of the front end of each of the pair of fastening pieces 28 of the coating fastening portion 23, respectively.

The crimp terminal 20 is formed of a conductive material. The material for forming the crimp terminal 20 may include at least one or more metal components selected from a group consisting of, for example, copper, aluminum, iron, and magnesium. The surface of the crimp terminal 20 may be plated, or may not be plated.

The crimp terminal 20 may contain copper or aluminum as a main component. Note that the main component indicates a metal component with the highest molar ratio among metal components contained in the crimp terminal 20. The metal component with the highest molar ratio among the metal components contained in the crimp terminal 20 may be present in a molar ratio of 50% or more, 60% or more, 70% or more, 80% or more, 90% or more, or 95% or more. The material of the crimp terminal 20 may be, for example, copper, aluminum, or an alloy containing these metal components. In view of conductivity, the crimp terminal 20 is preferably formed of copper or a copper alloy.

The anti-corrosive material 40 is provided to a portion in which the conductor 11 and the crimp terminal 20 contact with each other. When moisture adheres between the conductor 11 of the electric wire 10 and the crimp terminal 20, corrosion is easily caused. Thus, when the anti-corrosive material 40 is provided to the contact portion of the conductor 11 and the crimp terminal 20, adhesion of moisture between the conductor 11 of the electric wire 10 and the crimp terminal 20 can be prevented, and corrosion can be suppressed. In particular, when different types of metal components are used for the conductor 11 and the crimp terminal 20, for example, when the conductor 11 is aluminum or an aluminum alloy, and the crimp terminal 20 is copper or a copper alloy, corrosion is easily caused. Thus, corrosion can be suppressed by providing the anti-corrosive material 40.

As illustrated in FIG. 1, the anti-corrosive material 40 is provided from the first intermediate portion 24 to the coating fastening portion 23. Specifically, the anti-corrosive material 40 is provided to the first intermediate portion 24, the conductor crimp portion 22, the second intermediate portion 25, and the coating fastening portion 23.

In the first intermediate portion 24, an area near the distal end of the conductor 11 is more exposed than an area near the conductor crimp portion 22, and the anti-corrosive material 40 covers the distal end of the conductor 11.

In the conductor crimp portion 22, the surface of the outer circumference of the conductor 11 is covered with the conductor crimp portion 22, and the anti-corrosive material 40 covers a gap between the pair of conductor fastening pieces 27. With this, penetration of moisture into the inside of the pair of conductor fastening pieces 27 can be suppressed. In the conductor crimp portion 22, the conductor 11 is surrounded by the conductor crimp portion 22, and hence may not directly contact with the anti-corrosive material 40.

In the second intermediate portion 25, the conductor 11 being exposed and the electric wire 10 in which the conductor 11 is covered with the insulative coating 12 are arranged, and the anti-corrosive material 40 covers the conductor 11 and the insulative coating 12. In the second intermediate portion 25, a space surrounded by the conductor crimp portion 22, the coating fastening portion 23, and the side wall 30 of the second intermediate portion 25 is present, and the anti-corrosive material 40 covers the electric wire 10 from above in the space.

As understood from FIG. 2 and FIG. 3, the upper end of the side wall 30 of the second intermediate portion 25 is higher than the upper end of the conductor 11. Even when the upper end of the side wall 30 is lower than the upper end of the conductor 11, the anti-corrosive material 40 can be retained in the gap formed between the conductor 11 and the side wall 30, and the anti-corrosive material 40 can be retained on the conductor 11 due to the surface tension of the anti-corrosive material 40. However, when the upper end of the side wall 30 is higher than the upper end of the conductor 11, the side wall 30 of the second intermediate portion 25 functions as a wall for retaining the anti-corrosive material 40. As a result, the anti-corrosive material 40 can easily be retained by the side wall 30 even when the anti-corrosive material 40 is applied over the conductor 11. Thus, the anti-corrosive material 40 can be prevented from dripping beyond the side wall 30 onto the outer surface of the side wall 30.

The upper end of the side wall 30 of the second intermediate portion 25 may be higher than the upper end of the electric wire 10 covered with the insulative coating 12. With this, even when the anti-corrosive material 40 is applied over the electric wire 10, the anti-corrosive material 40 can easily be retained by the side wall 30. Thus, the anti-corrosive material 40 can further be prevented from dripping beyond the side wall 30 onto the outer surface of the side wall 30.

As illustrated in FIG. 3, the side wall 30 of the second intermediate portion 25 extends upward. With this, as compared to a case where the side wall 30 of the second intermediate portion 25 surrounds the electric wire 10, the upper end of the side wall 30 is higher. Thus, the amount of the anti-corrosive material 40 retained over the electric wire 10 can be increased. Therefore, the anti-corrosive material 40 can further be prevented from dripping beyond the side wall 30 onto the outer surface of the side wall 30. The side wall 30 of the second intermediate portion 25 may extend linearly upward.

The height of the side wall 30 of the second intermediate portion 25 is higher on the coating fastening portion 23 side than on the conductor crimp portion 22 side. In the second intermediate portion 25, the height of the electric wire 10 is higher on the coating fastening portion 23 side than on the conductor crimp portion 22 side. Thus, when the height of the side wall 30 is higher on the coating fastening portion 23 side than on the conductor crimp portion 22 side, the anti-corrosive material 40 can further be prevented from dripping beyond the side wall 30 onto the outer surface of the side wall 30. Note that the height of the side wall 30 of the second intermediate portion 25 may be higher as approaching the coating fastening portion 23 from the conductor crimp portion 22.

In the second intermediate portion 25, the anti-corrosive material 40 may contact with the front surface of the fastening pieces 28. In the terminal-equipped electric wire 1 described above, even when a portion of the conductor 11 covered with the insulative coating 12 is reduced in the second intermediate portion 25 due to a manufacturing error, the anti-corrosive material 40 is applied between the conductor 11 of the electric wire 10 and the crimp terminal 20. Thus, corrosion due to adhesion of moisture can further be suppressed.

The anti-corrosive material 40 may be provided to fill a first gap 28i being a gap surrounded by the inner surface 28g of the first fastening piece 28a, the distal end surface 28e of the first fastening piece 28a, and the insulative coating 12. Further, the anti-corrosive material 40 may be provided to fill a second gap 28j being a gap surrounded by the inner surface 28h of the second fastening piece 28b, the distal end surface 28f of the second fastening piece 28b, and the insulative coating 12. Further, the anti-corrosive material 40 may be provided to fill a third gap 28k being a gap surrounded by the outer surface 28c of the first fastening piece 28a, the outer surface 28d of the second fastening piece 28b, and the insulative coating 12. When the anti-corrosive material 40 is applied to fill the first gap 28i, the second gap 28j, and the third gap 28k, penetration of moisture into the second intermediate portion 25 through those gaps can be suppressed.

As illustrate in FIG. 4, the distal end of the first fastening piece 28a is curled with the inner surface 28g facing inward, and a fourth gap 28l being a gap formed by the inner surface 28g of the first fastening piece 28a is provided at the distal end of the first fastening piece 28a. The distal end surface 28e of the first fastening piece 28a may or may not contact with the inner surface 28g of the first fastening piece 28a. The distal end of the second fastening piece 28b is curled with the inner surface 28h facing inward, and a fifth gap 28m being a gap formed by the inner surface 28h of the second fastening piece 28b is provided at the distal end of the second fastening piece 28b. The distal end surface 28f of the second fastening piece 28b may or may not contact with the inner surface 28h of the second fastening piece 28b.

The anti-corrosive material 40 may be provided to fill a part of at least one of the fourth gap 28l and the fifth gap 28m. The anti-corrosive material 40 may not fill the fourth gap 28l, or may fill the entire fourth gap 28l. Further, the anti-corrosive material 40 may not fill the fifth gap 28m, or may fill the entire fifth gap 28m. On the upper surface of the contact portion in which the outer surface 28c of the first fastening piece 28a and the outer surface 28d of the second fastening piece 28b contact with each other, the anti-corrosive material 40 may or may not be provided.

The anti-corrosive material 40 can be formed by applying a liquid anti-corrosive material to the portion in which the conductor 11 and the crimp terminal 20 contacts with each other, such as the contact portion of the conductor 11 and the second intermediate portion 25, and then curing it. The anti-corrosive material 40 may be, for example, a resin obtained by curing at least one of a monomer and an oligomer. At least one of the monomer and the oligomer may be an ultraviolet-curable resin or the like. The ultraviolet-curable resin can instantly be cured upon exposure to ultraviolet light.

As described above, the terminal-equipped electric wire 1 according to the present embodiment includes the electric wire 10 and the crimp terminal 20. The electric wire 10 includes the conductor 11 and the insulative coating 12 that covers the conductor 11. The crimp terminal 20 includes the conductor crimp portion 22 that crimps the conductor 11, the coating fastening portion 23 that includes the first fastening piece 28a and the second fastening piece 28b and fastens the insulative coating 12 of the electric wire 10 by the first fastening piece 28a and the second fastening piece 28b, and the second intermediate portion 25. The second intermediate portion 25 connects the conductor crimp portion 22 and the coating fastening portion 23 to each other. The outer surface 28c of the first fastening piece 28a and the outer surface 28d of the second fastening piece 28b contact with each other. The upper end of the side wall 30 of the second intermediate portion 25 is higher than the upper end of the conductor 11.

In the terminal-equipped electric wire 1, the outer surface 28c of the first fastening piece 28a and the outer surface 28d of the second fastening piece 28b contact with each other. Thus, as compared to a case of fastening with overlap, at the time of fastening by the first fastening piece 28a and the second fastening piece 28b, the side wall 30 of the second intermediate portion 25 can be prevented from collapsing inward and being curved along with the first fastening piece 28a and the second fastening piece 28b. With this, as compared to a state before fastening the insulative coating 12 of the electric wire 10, the height of the side wall 30 of the second intermediate portion 25 can be maintained.

The upper end of the side wall 30 of the second intermediate portion 25 is higher than the upper end of the conductor 11. With this, the side wall 30 of the second intermediate portion 25 functions as a wall for retaining the anti-corrosive material 40, and hence the anti-corrosive material 40 can easily be retained by the side wall 30 even when the anti-corrosive material 40 is applied over the conductor 11. Thus, the anti-corrosive material 40 can be prevented from dripping beyond the side wall 30 onto the outer surface of the side wall 30.

Therefore, according to the terminal-equipped electric wire 1 according to the present embodiment, the anti-corrosive material 40 can be prevented from dripping down from the side wall 30 of the second intermediate portion 25. The anti-corrosive material can be prevented from adhering to the side surface or the back surface of the crimp terminal 20, and hence an influence thereof on insertion into the housing can be suppressed.

Further, the outer surface 28c of the first fastening piece 28a and the outer surface 28d of the second fastening piece 28b contact with each other, and hence the first fastening piece 28a and the second fastening piece 28b can be prevented from excessively collapsing inward beyond the side wall 30 of the second intermediate portion 25. Thus, it is possible to suppress tearing at the boundary between the side wall 30 of the second intermediate portion 25 and the fastening pieces 28 and prevent generation of a shear crack.

The terminal-equipped electric wire 1 can be used for a wire harness that is used in a vehicle such as an automobile.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A terminal-equipped electric wire comprising:
an electric wire including:
a conductor; and
an insulative coating that covers the conductor; and
a crimp terminal including:
a conductor crimp portion that crimps the conductor;
a coating fastening portion that includes a first fastening piece and a second fastening piece and fastens the insulative coating of the electric wire by the first fastening piece and the second fastening piece; and
an intermediate portion that connects the conductor crimp portion and the coating fastening portion, wherein
an outer surface of the first fastening piece and an outer surface of the second fastening piece contact with each other, and
an upper end of a side wall of the intermediate portion is higher than an upper end of the conductor.

2. The terminal-equipped electric wire according to claim 1, further comprising:
an anti-corrosive material being provided to a portion in which the conductor and the crimp terminal contact with each other.

3. The terminal-equipped electric wire according to claim 1, wherein
the side wall of the intermediate portion extends upward.

4. The terminal-equipped electric wire according to claim 1, wherein
the coating fastening portion fastens the insulative coating of the electric wire so that the outer surface of the first fastening piece and the outer surface of the second fastening piece contact with the insulative coating.
